(19) United States
(12) Patent Application Publication
(10) Pub. No.: US 2009/0132762 A1
(43) Pub. Date: May 21, 2009

(54) REMOVABLE NONVOLATILE MEMORY SYSTEM WITH FUNCTIONAL INHIBITION

(75) Inventor: Yosuke Muraki, Campbell, CA (US)

Correspondence Address: LAW OFFICES OF MIKIO ISHIMARU, 333 W. EL CAMINO REAL, SUITE 330, SUNNYVALE, CA, 94087, US

(73) Assignees: SONY CORPORATION, Tokyo (JP); SONY ELECTRONICS INC., Park Ridge, NJ (US)

(21) Appl. No.: 11/941,405

(22) Filed: Nov. 16, 2007

(51) Int. Cl. G06F 12/00

(52) U.S. Cl. 711/115; 711/E12.001

(57) ABSTRACT

A removable nonvolatile memory system is provided including inserting a nonvolatile memory into an electronic system; storing timing information onto a passive device coupled with the nonvolatile memory; extracting the nonvolatile memory from the electronic system; and enabling a read function from the nonvolatile memory based on the timing information stored on the passive device.

### TECHNICAL FIELD

The present invention relates generally to a memory system and more particularly to a removable nonvolatile memory system.

### BACKGROUND ART

In the connected world, people create, transport, store, and consume vast amount of information or data ranging from making a phone call, using the facsimile machine, and using the Internet to name a few. The technologies that keep people connected are ubiquitous and always available. Some of these technologies to transport vast amounts of data involve network systems, such as routers and switches. There are different types of network systems utilized across the Internet including local area network (LAN), storage area network (SAN), metropolitan area network (MAN), and wide area network (WAN). Network systems also provide various connectivity options, such as wired, wireless, electrical, or optical.

However, as vast and pervasive the connected world has become, so has the expectation availability, portability, and security of data. Whether data is created on a laptop, handheld device, downloaded, or transferred, data security is a quintessential as the electronics used in the creation, transportation, storage, and consumption of the data. Data may range from enterprise information to personal notes and pictures. Whatever the content, it is important to some users.

One particular area for data security is in the storage of nonvolatile memories. These memories may include magnetic hard disk drive and nonvolatile random access memories. The nonvolatile memories allow storage of data while providing portable without the need for a power supply, such as a battery. As valuable as the portability may be for data storage and transportation, it presents potential security risk.

Thus, a need still remains for a memory system for improving data security for removable nonvolatile memories to be used with the electronic systems. In view of the ever-increasing need to save costs and improve efficiencies, it is more and more critical that answers be found to these problems.

Solutions to these problems have been long sought but prior developments have not taught or suggested any solutions and, thus, solutions to these problems have long eluded those skilled in the art.

### DISCLOSURE OF THE INVENTION

The present invention provides a removable nonvolatile memory system including inserting a nonvolatile memory into an electronic system; storing timing information onto a passive device coupled with the nonvolatile memory; extracting the nonvolatile memory from the electronic system; and enabling a read function from the nonvolatile memory based on the timing information stored on the passive device.

Certain embodiments of the invention have other aspects in addition to or in place of those mentioned or obvious from the above. The aspects will become apparent to those skilled in the art from a reading of the following detailed description when taken with reference to the accompanying drawings.

### BRIEF DESCRIPTION OF THE DRAWINGS

FIG. 1 is a schematic view of an electronic system with a removable nonvolatile memory system in an application example of an embodiment of the present invention;

FIG. 2 is a schematic view of the removable nonvolatile memory system in an embodiment of the present invention;

FIG. 3 is a graphical view of the operation of the removable nonvolatile memory system of FIG. 2; and

FIG. 4 is a flow chart of a removable nonvolatile memory system for operation of the removable nonvolatile memory system in an embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail. Likewise, the drawings showing embodiments of the system are semi-diagrammatic and not to scale and, particularly, some of the dimensions are for the clarity of presentation and are shown greatly exaggerated in the drawing FIGs. Generally, the invention can be operated in any orientation. In addition, where multiple embodiments are disclosed and described having some features in common, for clarity and ease of illustration, description, and comprehension thereof, similar and like features one to another will ordinarily be described with like reference numerals.

For expository purposes, the term “horizontal” as used herein is defined as a plane parallel to the plane or surface of the integrated circuit, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane. The term “on” means there is direct contact among elements. The term “system” as used herein means and refers to the method and to the apparatus of the present invention in accordance with the context in which the term is used.

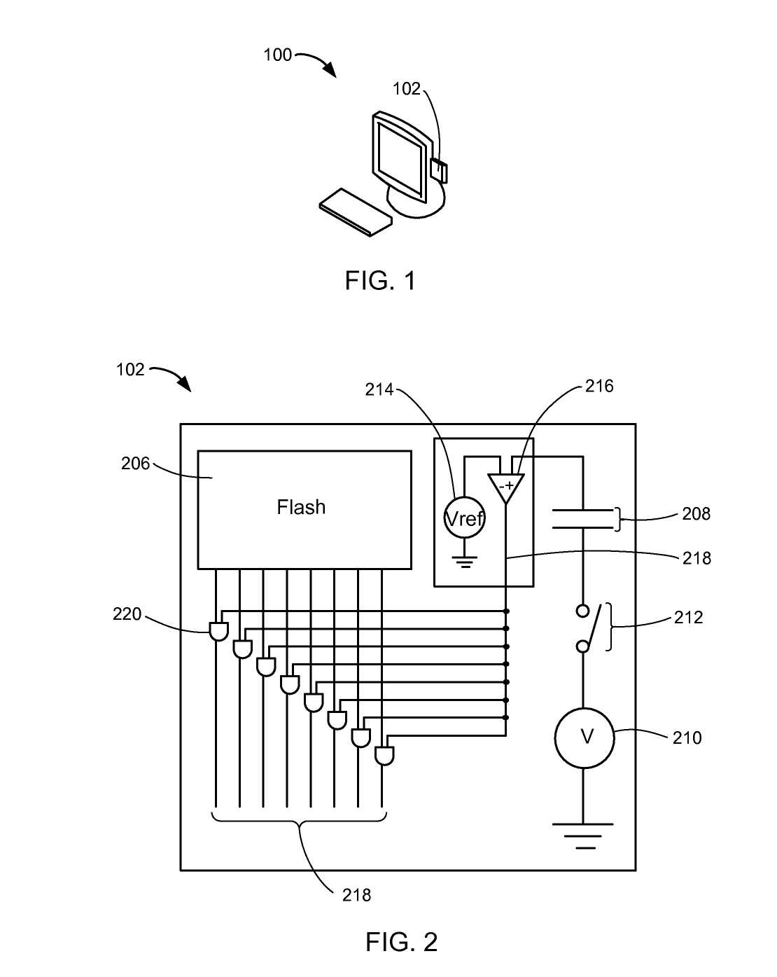

Referring now to FIG. 1, therein is shown a schematic view of an electronic system 100 with a removable nonvolatile memory system 102 in an application example of an embodiment of the present invention. The electronic system 100, such as desktop computer, may store data onto the removable nonvolatile memory system 102, such as removable hard drive or a nonvolatile memory stick. Also, the removable nonvolatile memory system 102 may also be inserted into the electronic system 100 to access the information from the removable nonvolatile memory system 102.

For illustrative purposes, the application of the removable nonvolatile memory system 102 is described as storing to and from the electronic system 100, although it is understood that the storage and reading of the data or information from the removable nonvolatile memory system 102 may be perform by another electronic system (not shown). For example, a smart phone (not shown) may store or read data that may be read or stored by, respectively, by the electronic system 100.

The portability of the removable nonvolatile memory system 102 allows ease of storage, transport, and usage of data stored therein at other systems at different locations. The removable nonvolatile memory system 102 may be used to even backup important data for a limited amount of time.

Referring now to FIG. 2, therein is shown a schematic view of the removable nonvolatile memory system in an embodiment of the present invention. As an example, the removable nonvolatile memory system 102 may be implemented with a nonvolatile memory 206, such as FLASH memory.

The removable nonvolatile memory system 102 also includes a passive device 208 for providing a timing function for the access time to the nonvolatile memory 206. A power source 210, such as a voltage source, may be included in the electronic system 100 of FIG. 1 and is used to store the timing information into the passive device 208 when a switch 212 is closed. For example, the passive device 208 may be implemented with a capacitor and the timing information may be stored with a voltage value based on the properties and material system of the capacitor, the voltage level from the power source 210, and the charging time of the capacitor.

The passive device 208 may be selected to provide a predetermined time from the charge or generally speaking the timing information. The timing information stored on the passive device 208 may also be controlled by adjusting the time the switch 212 is closed or the application of the power source 210.

If the removable nonvolatile memory system 102 is removed or extracted from the electronic system 100, it equivalently loses its power supply similar to the power source 210 being turned off, the switch 212 put to an opened position, or a combination thereof. With the removable nonvolatile memory system 102 removed, the passive device 208 provides a timing function for the data stored in the nonvolatile memory 206 to remain readable, non-writeable, or a combination thereof.

The readability or write inhibition may be selectable and settable. The selection may be performed with the electronic system 100 or within the removable nonvolatile memory system 102. For example, the removable nonvolatile memory system 102 may include a mechanical switch the may be set to a position for readability, writable inhibition, or the combination thereof.

For example, the passive device 208 implemented as a capacitor will discharge the stored voltage for a specific time. The voltage level from the passive device 208 may be compared to a voltage reference 214 with a comparator 216, such as operational amplifier. If the voltage level from the passive device 208 goes below the voltage reference 214, the comparator 216 will disable a read path 218 from the nonvolatile memory 206. The read path 218 may be disabled, for example, by input a logic zero into read gates 220 or AND gates such that all the read path 218 will output only logic zeros.

The passive device 208 may be implemented with a number of elements or components. For example, the passive device 208 may be implemented with a number of capacitors in a parallel, series, or a combination thereof to improve resolution of the discharge time. The capacitors may be of different values.

For illustrative purposes, the removable nonvolatile memory system 102 is described with the passive device 208 providing a timing function with the discharge of charge from the capacitor, although it is understood that other types of the passive device 208 may be used to provide the timing function. For example, the passive device 208 is generally a device based on the structural construction and the material system that provides a timing function or more specifically a count down function without a need for an external power source with the removable nonvolatile memory system 102 extracted from the electronic system 100. The passive device 208 may be implemented by other electrical components, a combination of electrical components, mechanical components, or a combination thereof.

Also for illustrative purposes, the removable nonvolatile memory system 102 is shown with the passive device 208, the comparator 216, the voltage reference 214, the nonvolatile memory 206, and the read gates 220, although it is understood that the configuration of the removable nonvolatile memory system 102 may differ. For example, the removable nonvolatile memory system 102 may include volatile memory, such as static random access memory (SRAM) or dynamic random access memory (DRAM), for extending the life of the nonvolatile memory 206 by minimizing the write and erase cycles.

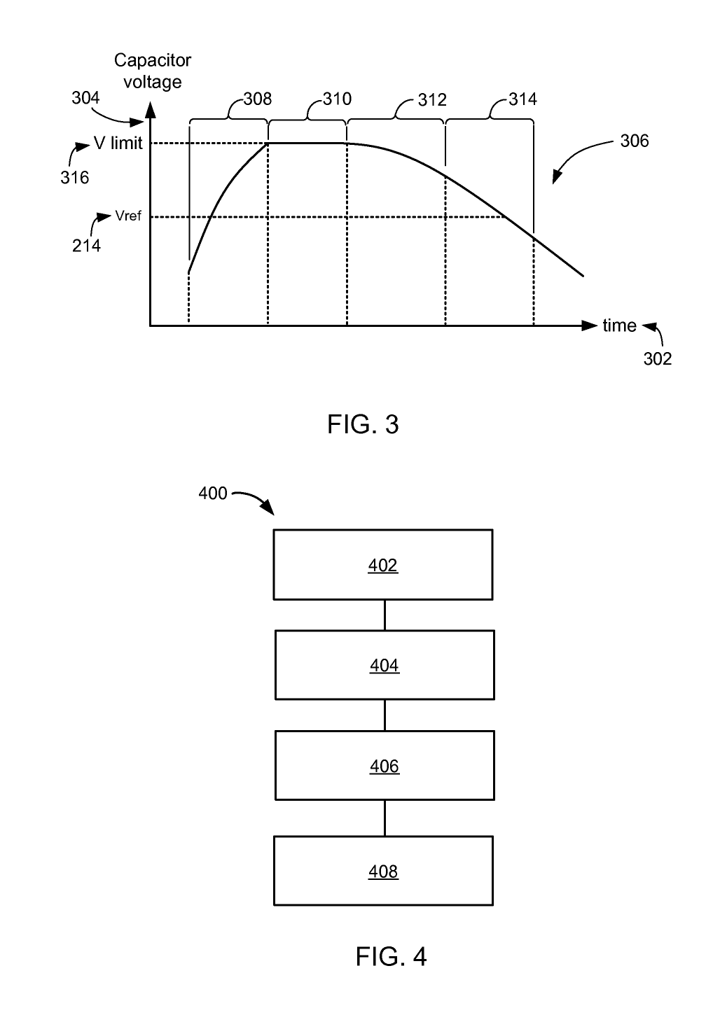

Referring now to FIG. 3, therein is shown a graphical view of the operation of the removable nonvolatile memory system 102 of FIG. 2. The graphical view depicts operation of the passive device 208 of FIG. 2 as a capacitor. The x-axis is represents time 302. The y-axis represents a capacitor voltage 304.

A curve 306 represents the different voltage levels over the time 302 and over specific operations of the removable nonvolatile memory system 102 of FIG. 2. The curve 306 may be viewed as having different portions. For example, the curve 306 may include a charging region 308, a charged region 310, a read region 312, and a read inhibited region 314.

The charging region 308 may represent the switch 212 of FIG. 2 in a closed position enabling the power source 210 of FIG. 2 charging the passive device 208. The charging of the passive device 208 reaches a voltage limit 316 if the switch 212 remained closed sufficiently long enough. The voltage limit 316 may represent the maximum voltage level for the passive device 208 or a predetermined level for a specified timing based on the discharge of the passive device 208. As the passive device 208 charged to the voltage limit 316, the curve 306 transitions from the charging region 308 to the charged region 310.

The charged region 310 may represent the maximum voltage level of the passive device 208 having the voltage limit 316 and the switch 212 in a closed position. If the voltage limit 316 represents a predetermined voltage level to be stored on the passive device 208, the switch 212 may be in an opened position such that the power source 210 will not continue to charge the passive device 208. Within both the charging region 308 and the charged region 310, the nonvolatile memory 206 of FIG. 2 in the removable nonvolatile memory system 102 may be written and read.

With the removable nonvolatile memory system 102 extracted from the electronic system 100 of FIG. 1, the curve 306 may transition from the charged region 310 to the read region 312. The nonvolatile memory 206 in the removable nonvolatile memory system 102 is both readable or not writeable in the read region 312. In the read region 312, the passive device 208 is not being charged by the power source 210 since it is decoupled from the electronic system 100. The passive device 208 discharges at a known rate for a range of temperature, process of the passive device 208, and the voltage limit 316. While the voltage from the passive device 208 is above the voltage reference 214 of FIG. 2, the comparator 216 of FIG. 2 may output a logic high to the read gates 220 of FIG. 2 enabling the read function.

The read function is enabled with the voltage from the passive device 208 even if the removable nonvolatile memory system 102 is inserted into a system, such as the electronic system 100, to read the data from the nonvolatile memory 206. While the removable nonvolatile memory system 102 is in the read region 312, the nonvolatile memory 206 may or may not be written even with the removable nonvolatile memory system 102 is inserted into the system for reading the data. The writable inhibition may depend on the selection or setting of the removable nonvolatile memory system 102 as mentioned in FIG. 2. As a further example, the removable nonvolatile memory system 102 may transition from the read region 312 to another charging region (not shown) when the removable nonvolatile memory system 102 is inserted into a system for reading.

As the voltage from the passive device 208 approximates the level of the voltage reference 214, the curve 306 may transition from the read region 312 to the read inhibited region 314. With the voltage from the passive device 208 approximately at or below the voltage reference 214, the comparator 216 may output a logic zero to the read gates 220 thereby masking the read path 218 of FIG. 2 to logic zeros and inhibiting read output from the nonvolatile memory 206.

The electronic system 100 or a similar system capable of receiving the removable nonvolatile memory system 102 may retrieve status from the removable nonvolatile memory system 102 inserted therein. The status may include the state or the voltage of the passive device 208 to determine if the passive device 208 is readable, writeable, or a combination thereof. For example, the mechanical setting described in FIG. 2 may provide the voltage from the passive device 208 to the electronic system 100. With the removable nonvolatile memory system 102 inserted into the electronic system 100, the removable nonvolatile memory system 102 may potentially remain in the read region 312.

The discharge time of the passive device 208 in the read region 312 represents the timing function provided by the passive device 208 without an external power supply. The selection of the passive device 208, such as the capacitance value, may determine the maximum specified time, such as 10 minutes, 20 minutes, or 30 minutes.

The removable nonvolatile memory system 102 may complete write function and be set to enter a time down mode or a discharge mode while still within the electronic system 100. Alternatively, the removable nonvolatile memory system 102 may complete write function and may not enter the discharge mode until removed from the electronic system 100.

As mentioned earlier, the curve 306 in the graphical view represents the timing function for a capacitor type of the passive device 208. Other types of the passive device 208 may be used including different electrical components, mechanical components, or a combination thereof where the structure and the material system of the passive device 208 provides the timing function without an external power source 210.

Referring now to FIG. 4, therein is shown a flow chart of a removable nonvolatile memory system 400 for operation of the removable nonvolatile memory system 102 in an embodiment of the present invention. The system 400 includes inserting a nonvolatile memory into an electronic system in a block 402; storing timing information onto a passive device coupled with the nonvolatile memory in a block 404; extracting the nonvolatile memory from the electronic system in a block 406; and enabling a read function from the nonvolatile memory based on the timing information stored on the passive device in a block 408.

Yet other important aspects of the embodiments include that it valuably supports and services the historical trend of reducing costs, simplifying systems, and increasing performance.

These and other valuable aspects of the embodiments consequently further the state of the technology to at least the next level.

Thus, it has been discovered that the electronic system of the present invention furnishes important and heretofore unknown and unavailable solutions, capabilities, and functional aspects for improving reliability in systems. The resulting processes and configurations are straightforward, cost-effective, uncomplicated, highly versatile, and effective, can be implemented by adapting known technologies, and are thus readily suited for efficiently and economically manufacturing stackable integrated circuit package system.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A removable nonvolatile memory system comprising:
inserting a nonvolatile memory into an electronic system;
storing timing information onto a passive device coupled with the nonvolatile memory;
extracting the nonvolatile memory from the electronic system; and
enabling a read function from the nonvolatile memory based on the timing information stored on the passive device.

2. The system as claimed in claim 1 further comprising disabling the read function from the nonvolatile memory based on the timing information from the passive device.

3. The system as claimed in claim 1 wherein storing timing information onto the passive device includes setting a predetermined time with the timing information stored on the passive device.

4. The system as claimed in claim 1 wherein enabling the read function from the nonvolatile memory based on the timing information stored on the passive device includes generating a specified time based on the passive device without an external power source.

5. The system as claimed in claim 1 wherein enabling the read function from the nonvolatile memory based on the timing information stored on the passive device includes disabling a write function to the nonvolatile memory based on the timing information stored on the passive device.

6. A removable nonvolatile memory system comprising:
inserting a nonvolatile memory into an electronic system;
storing timing information onto a passive device coupled with the nonvolatile memory;
extracting the nonvolatile memory from the electronic system;
enabling a read function from the nonvolatile memory based on the timing information stored on the passive device by not masking a read path from the nonvolatile memory; and
disabling a write function to the nonvolatile memory based on the timing information stored on the passive device.

7. The system as claimed in claim 6 wherein storing the timing information onto the passive device includes storing a voltage level onto a capacitor.

8. The system as claimed in claim 6 wherein enabling the read function from the nonvolatile memory based on the timing information stored on the passive device includes enabling the read function with a discharge time of a capacitor.

9. The system as claimed in claim 6 wherein:
inserting the nonvolatile memory into the electronic system includes:
connecting a power source with the passive device; and
storing the timing information onto the passive device includes:
charging a capacitor with the power source.

10. The system as claimed in claim 6 wherein enabling the read function from the nonvolatile memory based on the timing information stored on the passive device includes comparing a charge from a capacitor with a voltage reference.

11. A removable nonvolatile memory system comprising:
a nonvolatile memory inserted for storing data; and
a passive device coupled to the nonvolatile memory for storing timing information and for enabling a read function from the nonvolatile memory based on the timing information.

12. The system as claimed in claim 11 wherein the passive device coupled to the nonvolatile memory for disabling the read function from the nonvolatile memory based on the timing information stored on the passive device.

13. The system as claimed in claim 11 wherein the passive device provides a predetermined time based on the timing information stored the passive device.

14. The system as claimed in claim 11 wherein the passive device provides a specified time based on the timing information stored the passive device without an external power source.

15. The system as claimed in claim 11 wherein the passive device coupled to the nonvolatile memory for disabling a write function from the nonvolatile memory based on the timing information stored on the passive device.

16. The system as claimed in claim 11 wherein the passive device coupled to the nonvolatile memory for disabling a write function from the nonvolatile memory based on the timing information stored on the passive device and for enabling the read function by not masking a read path from the nonvolatile memory.

17. The system as claimed in claim 16 wherein the passive device includes a capacitor with the timing information stored onto the passive device by a voltage level.

18. The system as claimed in claim 16 wherein the passive device includes a capacitor with a discharge time for enabling the read function from the nonvolatile memory.

19. The system as claimed in claim 16 further comprising:
a comparator coupled to the passive device; and
a read gate coupled with the comparator for masking the read function from the nonvolatile memory.

20. The system as claimed in claim 16 further comprising:
a voltage reference; and
a comparator coupled to the voltage reference and the passive device for comparing a charge from the passive device with the voltage reference.
